(19) United States
(12) Patent Application Publication
(10) Pub. No.: US 2004/0250966 A1
(43) Pub. Date: Dec. 16, 2004

(54) Actuating mechanism for angles of light of vertical curtain

(76) Inventor: Shih-Tong Yu, Taipei (TW)

Correspondence Address: TROXELL LAW OFFICE PLLC, 5205 LEESBURG PIKE, SUITE 1404, FALLS CHURCH, VA, 22041, US

(21) Appl. No.: 10/461,490

(22) Filed: Jun. 16, 2003

(51) Int. Cl. E06B 9/26

(52) U.S. Cl. 160/176.1 R

(57) ABSTRACT

An actuating mechanism for angles of light of a vertical curtain, and more particularly, an actuating mechanism for adjusting angles of incoming light of a curtain having vertical slats, includes a rotating gear indirectly disposed between an interlocking gear and a driving gear thereof. The driving gear is disposed with deviation. Using an elastic clutch escape function and various diameters of the driving gear, the aforesaid structure is able to adapt to different torsion requirements for full breadth light shielding effects, as well as safe applications.

### BACKGROUND OF THE INVENTION

(a) Field of the Invention

The invention relates to an actuating mechanism for angles of light of a vertical curtain, and more particularly, to an actuating mechanism applied in a curtain having vertical slats, and capable of adjusting illuminating angles of incoming light, thereby providing total light shielding effects, an elastic escape function and adaptations to various torsions.

(b) Description of the Prior Art

Referring to FIG. 1 showing fundamental motion principles in adjustment of illumination angles for vertical curtains, an actuating mechanism 1 comprises a worm 13 and a worm gear 14 for multiplying torsion. A connection axis 12 is provided below the worm 13. The worm 13 is manually impelled so as to drive the worm gear 14, and to further have a center of the worm gear 14 drive an interlocking axis 12. The longitudinal interlocking axis 11 respectively drives shuttle assemblies 2, which then drive hanging shafts 21 below to further rotate slats 3, thereby adjusting incident angles of light beams.

The actuating mechanism 1 and the shuttles 2 are flexibly disposed at a sliding track 41 of the rail 4, such that the actuating mechanism 1 and the shuttles 2 are capable of passive and transverse movements. In addition, neighboring shuttles 2 are withdrawn and stacked using a propelling tongue-shaped board 22 correspondingly provided.

Referring to FIG. 2 showing a conventional vertical curtain, when the entire rail 4 is applied at inner sides 50 of a window frame 5, two ends of the rail 4 cannot be extended. Also, two ends of the rail 4 are provided with an end stopper 40 having a certain length L, respectively. During light-shielding operations of the slats 3 by the shuttles 2 using the actuating mechanism 1, a left side of the actuating mechanism 1 comes into contact with the end stopper 40. As a result, a gap G is formed between a control rod 7 and the inner sides 50 of the frame 5, respectively, and a complete shielding from light is failed.

Moreover, the actuating mechanism 1 is consisted of the worm 13 and the worm gear 14, and basically torsions thereof are unlikely to be adjusted. A purpose of the adjustment is to adapt to different weights carried based on numbers of slats 3 hung below the rail 4. Lengths of the curtain vary from one to four meters or even longer lengths, and numbers of slats 3 hung may also differ. Therefore, the weight carried is unevenly distributed, and counterforce and total reacting force produced upon the shuttles 2 are also unequal. It is obvious that this prior art is incapable of arranging different components for adapting to a wide range of torsion requirements.

Above all, largest impedance is formed when the actuating mechanism 1 of the prior art is turned to a limit thereof, and thus cogs of the worm gear are likely to be damaged once the counterforce generated is fed back to the cogs of the worm gear.

Therefore, an actuating mechanism according to the invention has an escape function and adaptations to different torsions, so as to accomplish complete light shielding effects.

### SUMMARY OF THE INVENTION

The object of the invention is to provide an actuating mechanism for adjusting angles of incoming light of a vertical curtain. According to the invention, a rotating gear is especially provided indirectly between corresponding interlocking gear and driving gear of the actuating mechanism, wherein the rotating gear and the interlocking gear are conically engaged. Also, the actuating mechanism has an elastic escape function and adaptations to various torsion, thereby accomplishing full breath light shielding effects.

### BRIEF DESCRIPTION OF THE DRAWINGS

FIG. 1 shows a conventional schematic view illustrating a rotation mechanism of a prior vertical curtain.

FIG. 2 shows a conventional elevational perspective view illustrating a rotation mechanism of a prior vertical curtain.

FIG. 3 shows a schematic view of the actuating mechanism according to the invention.

FIG. 4 shows an elevational schematic view according to the invention in application.

FIG. 5 shows a schematic view of an embodiment according to the invention.

FIG. 6 shows a schematic view illustrating an elastic clutch escape motion according to the invention.

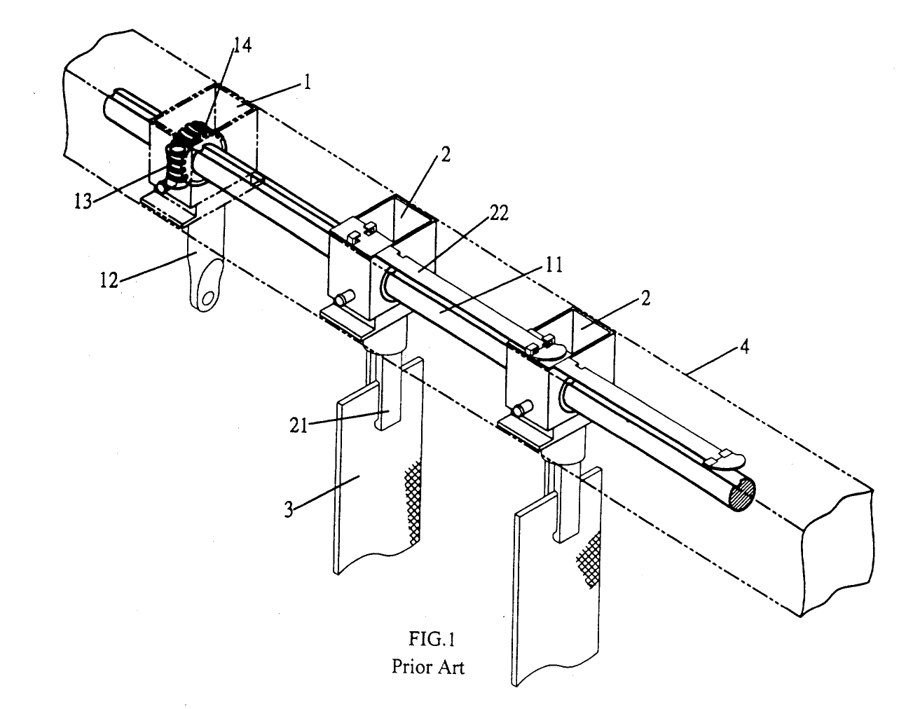

### DETAILED DESCRIPTION OF THE PREFERRED EMBODIMENTS

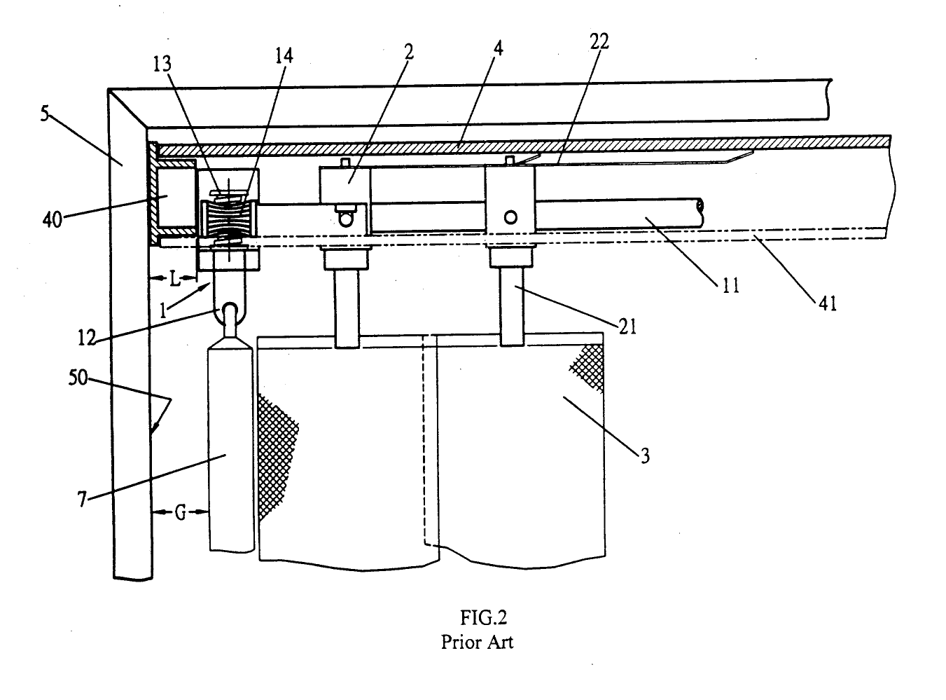

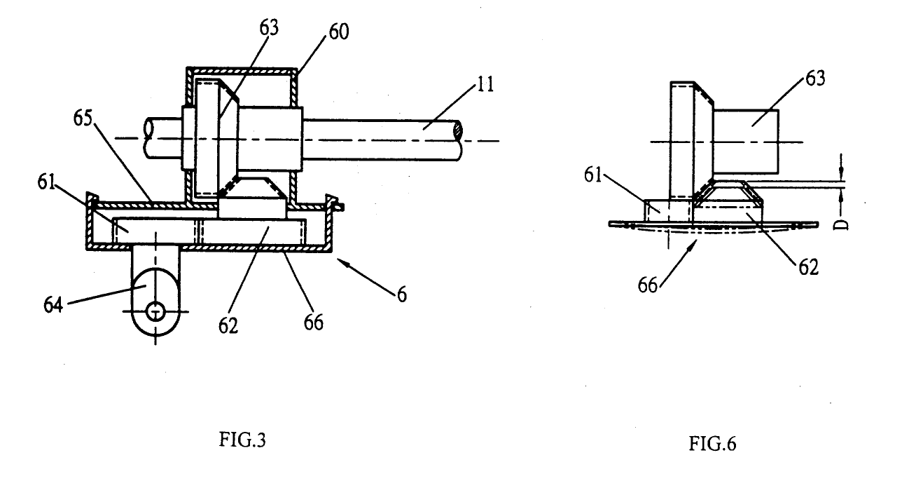

Referring to FIG. 3 showing an embodiment according to the invention, the invention comprises an eccentric actuating mechanism 6 having components thereof disposed in a housing 60. The housing 60 is provided at the sliding track 41 of the aforesaid rail 4 (as shown in FIG. 2). The actuating mechanism 6 and a corresponding interlocking axis 11 are connected by an interlocking gear 63. The interlocking gear 63 is driven by a rotating gear 62, which is driven by a driving gear 61. Below the driving gear 61 is a connection axis 64 provided for manual operations. The driving gear 61 is disposed at a bottom portion of the housing 60, and an elastic bottom board 66 is provided at a bottom portion of the rotating gear 62.

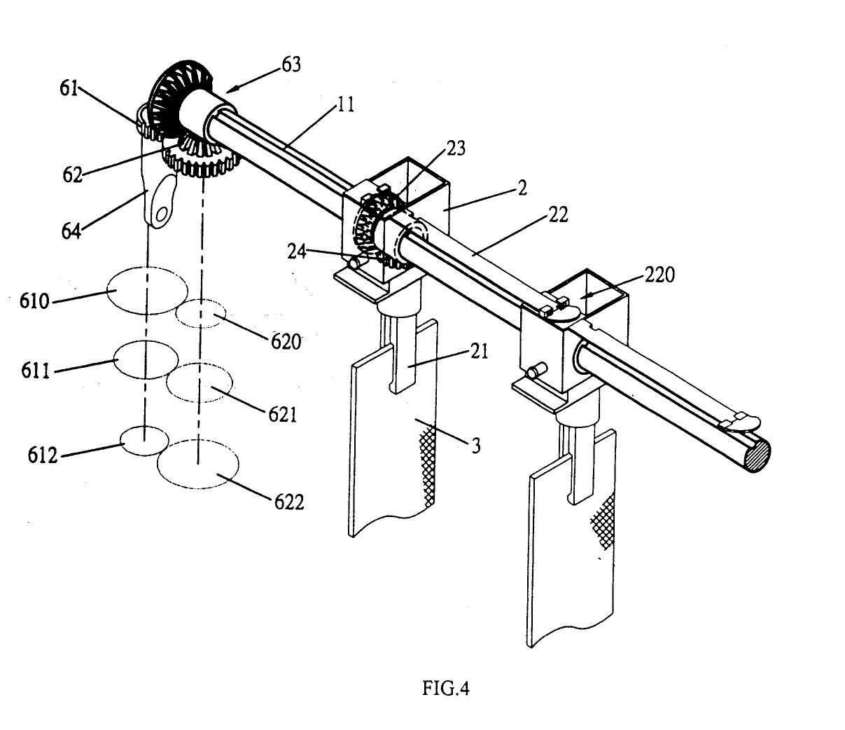

Referring to FIG. 4, a front end of the interlocking axis 11 is driven by the interlocking gear 63, and a rear end thereof drives a plurality of shuttles 2. Wherein, adjacent shuttles 2 are impelled by a propelling tongue-like board 22; that is, a mouth-hold 220 of a rear shuttle 2 is triggered by a front shuttle 2, thereby achieving dragging and driving, and stacking.

At an interior of the shuttle 2, an active gear 23 is impelled by the interlocking axis 11, and the active gear 23 then impels a passive gear 24 disposed at a hanging shaft 21 using conical engagement. Below the hanging shaft 21 is a vertical slat 3, and hence when the interlocking axis 11 drives related rotating components of the shuttles 2, the slats 3 are also driven for adjusting angles of incoming light.

When the actuating mechanism 6 is manually operated via the connection axis 64, the driving gear 61 is impelled, and a rotating gear 62 is subsequently impelled by the driving gear 61. Diameters of the driving gear 61 and the rotating gear 62 may be altered. For instance, a driving gear 610 having a larger diameter may be utilized to impel a smaller rotating gear 620; or the driving gear 61 may be changed to smaller driving gears 611 and 612, and rotating gears 621 and 622 having different diameters may be selected for different arrangements. Consequently, various torsions are acquired by the interlocking axis 11, and are capable of adapting to numbers of slats hung, thereby producing different forces having different degrees for facilitating operations by children or for relatively increasing operating speed.

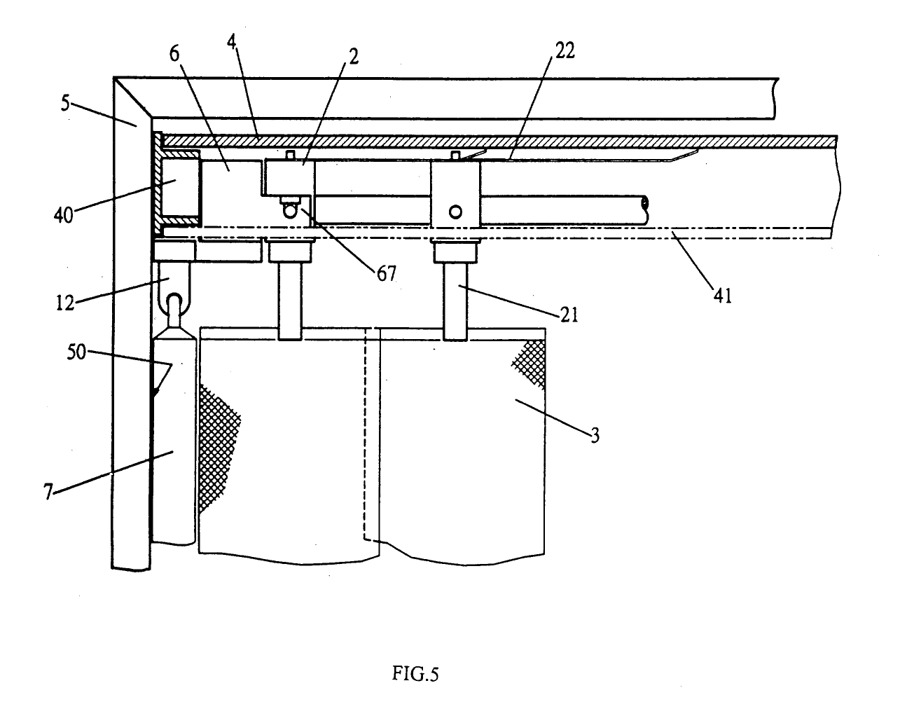

Referring to FIG. 5, according to an embodiment of the invention, the rail 4 is placed at inner sides of the frame 5. However, according to the invention, the eccentric actuating mechanism 6 is butted against the end stopper 40. For that reason, the interlocking axis 12 also becomes eccentric that a left side of the control rod 7 is pressed against the inner side 50 of the frame 5, whereas a right side thereof is joined with a relative side of the slat 3, thereby obtaining full width light shielding effects. In addition, the eccentric actuating mechanism 6 and the shuttles 2 are flexibly disposed at the sliding track 41 of the rail 4 in a similar way, and the actuating mechanism 6 and a first shuttle 2 are connected by a dragging plank 67 disposed at the actuating mechanism 6. Hence, the first shuttle 2 is impelled by the actuating mechanism 6, and the first and subsequent shuttles are impelled by a mobile connection using the propelling tongue-like boards 22.

Referring to FIG. 6 showing an elastic clutch escape motion according to the invention, the bottom board 66 is capable of elastic deformation. When a deformation force is greatest impedance from counterforce imposed on the interlocking gear 63, bevel cutting and pressing forces are produced between the interlocking gear 63 and the rotating gear 62. The bevel and pressing forces repress the gear 62, which then slumps due to elasticity of the bottom board 66, and thus forming an escape gap D. The existing of the gap D enables elastic clutching between the interlocking gear 63 and the rotating gear 62, thereby avoiding damages of cogs.

It is of course to be understood that the embodiment described herein is merely illustrative of the principles of the invention and that a wide variety of modifications thereto may be effected by persons skilled in the art without departing from the spirit and scope of the invention as set forth in the following claims.

1-2. (Canceled)

3. An actuating mechanism for controlling a plurality of slats of a vertical curtain connected to a frame, the actuating mechanism comprising:
a) an interlocking gear;
b) a rotating gear engaging and controlling rotation of the interlocking gear; and
c) a driving gear engaging and controlling rotation of the rotating gear and having a connection axle extending outwardly from a center thereof, wherein rotation of the connection axle controls the rotation of the interlocking gear, wherein a rotation axis of the interlocking gear and a rotation axis of the rotating gear are perpendicular to each other.

4. The actuating mechanism according to claim 3, wherein a rotation axis of the driving gear and the rotation axis of the rotating gear are parallel.

5. The actuating mechanism according to claim 3, further comprising:
a) a housing having the interlocking gear located therein; and
b) an elastic bottom board connected to the housing and forming an interior there between, the driving gear and the rotating gear are located on the elastic bottom board.

6. The actuating mechanism according to claim 5, wherein, when a predetermined rotation force between the interlocking gear and the rotating gear is exceeded, the elastic bottom board deforms allowing the interlocking gear and the rotating gear to be separated a predetermined distance.

7. The actuating mechanism according to claim 3, wherein an outer diameter of the driving gear and an outer diameter of the rotating gear are different.

8. The actuating mechanism according to claim 3, wherein the connection axle is located between one of the plurality of slats and the frame.
